(19) United States
(12) Patent Application Publication
(10) Pub. No.: US 2026/0211773 A1
(43) Pub. Date: Jul. 23, 2026

(54) ERROR REPORTING USING LINK PARITY LOCATIONS

(71) Applicant: Micron Technology, Inc., Boise, ID (US)

(72) Inventor: Scott E. SCHAEFER, Boise, ID (US)

(21) Appl. No.: 19/394,729

(22) Filed: Nov. 19, 2025

Related U.S. Application Data
(60) Provisional application No. 63/746,444, filed on Jan. 17, 2025.

(51) Int. Cl. G06F 11/10

(52) U.S. Cl. CPC G06F 11/1096

(57) ABSTRACT

In some implementations, a memory apparatus may obtain, from a host system, a first message comprising data and link parity information associated with the data. The memory apparatus may determine that the data includes one or more errors based on the link parity information. The memory apparatus may store a first value indicating that the data includes the one or more errors. The memory apparatus may provide, as part of a read request for the data, a second message comprising the data and a second value, the second value indicating that the data includes the one or more errors.

### CROSS-REFERENCE TO RELATED APPLICATION

This Patent Application claims priority to U.S. Provisional Ser. No. 63/746,444, filed on Jan. 17, 2025, entitled “ERROR REPORTING USING LINK PARITY LOCATIONS,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to error reporting using link parity locations.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of error reporting using link parity locations.

FIG. 2 shows an example of a data packet that supports error reporting using link parity locations.

FIGS. 3A and 3B are diagrams of an example of error reporting using link parity locations.

FIG. 4 is a flowchart of an example method associated with error reporting using link parity locations.

FIG. 5 is a flowchart of an example method associated with error reporting using link parity locations.

FIG. 6 is a flowchart of an example method associated with error reporting using link parity locations.

FIG. 7 is a flowchart of an example method associated with error reporting using link parity locations.

### DETAILED DESCRIPTION

Some systems may operate according to a protocol that supports a write burst mode in which a host system communicates a data packet to a memory system. The memory system may store a payload (e.g., user data) included in the data packet to one or more memory devices of the memory system. The data packet may further include control information associated with the payload, such as link parity information. Link parity information may be parity information (e.g., one or more error correction codes (ECCs) and/or one or more error detection codes (EDCs)) used to detect and/or correct one or more errors in the data packet that occur during communication (e.g., transmission and/or reception) of the data packet between the host system and the memory system.

For example, to communicate a data packet from the host system to the memory system, the host system may generate link parity information using the payload. The host system may provide the data packet, which may include the payload, the system metadata, and the link parity information, to the memory system. After obtaining the data packet, the memory system may perform an error control operation to attempt to detect and/or correct one or more errors in the payload and the system metadata using the link parity information.

In some examples, if the memory detects an error, such as an uncorrectable or critical error, then the memory system may inform the host system of the error by storing a value (e.g., a flag or other indication) to one or more registers, which may be referred to as “fault-mode registers” (FMRs). The memory system may provide a message indicating the value (e.g., the status) of the one or more registers to the host system (e.g., periodically and/or in response to a polling request from the host system). However, such an implementation may be relatively slow (e.g., around 30 nanoseconds), which may result in high latency associated with reporting such errors. High error reporting latency may reduce the ability of the host system to take corrective action, such as by reducing the amount of time available for the host system to attempt to rewrite or otherwise recover the data in the payload. Thus, a high error reporting latency may reduce the reliability of data written to the memory system.

Some implementations described herein enable error reporting using link parity locations. For example, a memory system may support a link parity feedback mode in which the memory system reports write-link errors as part of a read operation for a data packet. As described herein, a write-link error may be an error in data (e.g., a bit-flip or other data-corrupting event) that occurs during transfer of the data from the host system to the memory system (e.g., as part of a write operation).

By way of example, to write a payload (e.g., user data, mission data) to the memory system, the host system may generate link parity information for the payload by performing an error control operation on the payload. The host system may provide, and the memory system may obtain, a data packet that includes the payload and the link parity information. Based on, in response to, or otherwise associated with obtaining the data packet, the memory system may perform an error control operation on the data packet using the link parity information. If the memory system detects one or more errors in the data packet, then the memory system may store an indication that the data packet includes the one or more errors. For example, the memory system may store a value to one or more fault-mode registers (e.g., may set one or more flags of the fault-mode register(s)) indicating that the data packet includes the one or more errors. Additionally, or alternatively, the memory system may store a value to one or more memory arrays provisioned for parity information corresponding to the data packet.

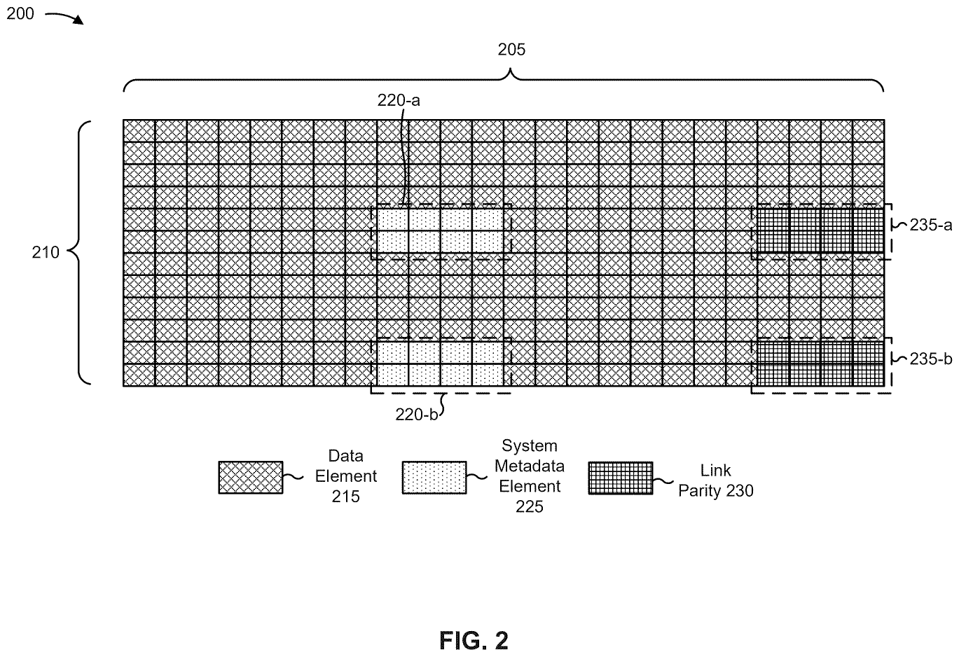

Subsequently, as part of a read operation for the payload, the memory system may generate a second data packet. As described in greater detail in connection with FIG. 2, the memory system may place a value indicating that the data packet includes the one or more errors in one or more portions of the second data packet provisioned for communication control information. The value may be a non-error-correcting code of the error control scheme used to generate the link parity information. The memory system may provide, and the host system may obtain, the second data packet. By identifying that the information in the one or more portions of the second data packet provisioned for communication control information includes a non-error-correcting code, the host system may determine that an error occurred as part of previously storing the payload to the memory system (e.g., the host system may identify that a write-link error occurred).

By enabling error reporting using link parity locations, the host system and/or the memory system may reduce the latency associated with such error reporting. Such reduced latency may improve system performance, for example by reducing the time used to recover from errors, thereby maintaining higher throughput levels. Further, such error reporting may improve the ability of the host system to take corrective action, such as by increasing the amount of time available for the host system to attempt to rewrite or otherwise recover the data in the payload. Thus, reduced error reporting latency may increase the reliability of data written to the memory system.

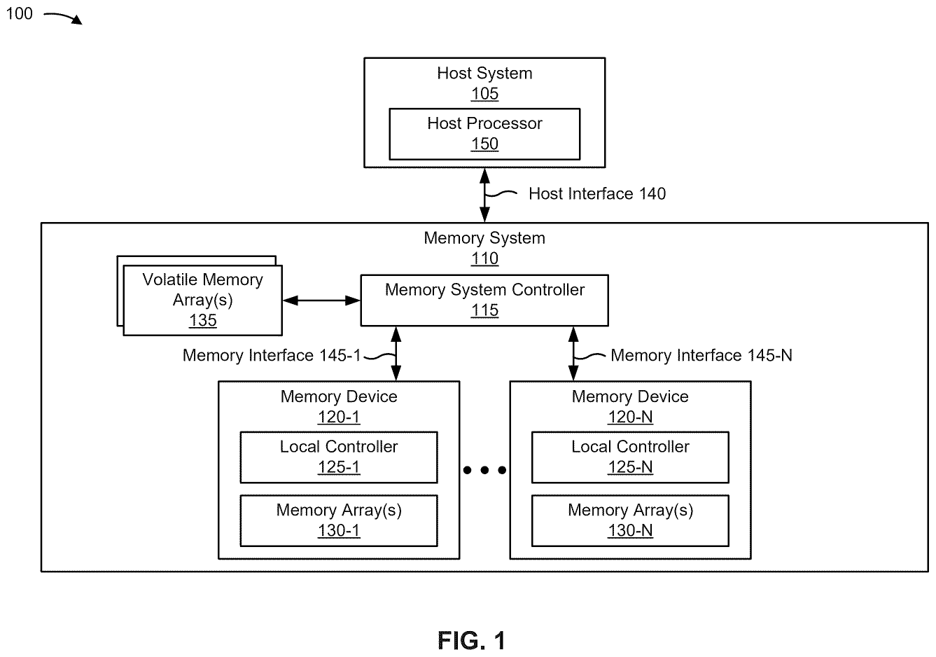

FIG. 1 is a diagram illustrating an example system 100 capable of error reporting using link parity locations. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or

methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to obtain, from a host system, a first message comprising data and link parity information associated with the data; determine that the data includes one or more errors based on the link parity information; store a first value indicating that the data includes the one or more errors; and provide, to the host system and as part of a read request for the data, a second message comprising the data and a second value, the second value indicating that the data includes the one or more errors.

In some implementations, one or more systems, devices, apparatuses, components, and/or controllers of FIG. 1 may be configured to obtain, from a host system, a first message comprising data and link parity information associated with the data; determine that the data includes one or more errors based on the link parity information; and selectively store selectively, based on whether the memory apparatus is operating in a link parity feedback mode, store a first value indicating that the data includes the one or more errors to one or more fault-mode registers or store a second value indicating that the data includes the one or more errors to one or more memory arrays provisioned for parity information corresponding to the data.

In some implementations, one or more systems, devices, apparatuses, components, and/or controllers of FIG. 1 may be configured to provide, to a memory apparatus, a command indicating that the memory apparatus is to operate in a link parity feedback mode; provide, to the memory apparatus, a first message comprising data and link parity information associated with the data; and obtain, from the memory apparatus and as part of a read request for the data, a second message comprising the data and a second value, the second value indicating that the data includes one or more errors.

In some implementations, one or more systems, devices, apparatuses, components, and/or controllers of FIG. 1 may be configured to communicate, via a host interface and to a memory apparatus, a first message comprising data and link parity information associated with the data; determine that the data includes one or more errors based on the link parity information; store, at the memory apparatus, a first value indicating that the data includes the one or more errors; and communicate, via the host interface and to a host system, a second message comprising the data and a second value, the second value indicating that the data includes the one or more errors.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 shows an example of a data packet 200 that supports error reporting using link parity locations. The data packet 200 illustrates a format of signaling communicated between a host system (e.g., the host system 105) and a memory apparatus (e.g., the memory system 110, one or more memory devices 120) specified by a communication protocol, such as a format used for a write burst operation.

The data packet 200 may include one or more elements arranged according to one or more time intervals 205, which may be referred to as “beats”, and one or more pins 210 of a bus (e.g., a host interface 140) between the host system and the memory apparatus. Said another way, each pin 210 of the bus may communicate a single element between the host system and the memory system during each time interval 205. An element corresponding to a given time interval 205 and a given pin 210 may represent a voltage level of the given pin 210 during the given time interval 205. For example, an element may be a single bit, such as a high state (e.g., a logic “1) or a low state (e.g., a logic “0”) at an edge (e.g., a rising edge, a falling edge) of a clock signal used as part of binary signaling. Additionally, or alternatively, an element may correspond to a voltage level of other signaling schemes, such as non-return-to-zero (NRZ) signaling, three-level pulse-amplitude modulation (PAM-3) signaling, and/or PAM-4 signaling, among other examples.

The one or more elements may include one or more data elements 215. The one or more data elements 215 of the data packet may represent the payload of the data packet 200, such as user data communicated between the host system and the memory system.

In some examples, the communication protocol may specify one or more locations 220 (e.g., one or more subsets of the time intervals 205 and/or the pins 210, one or more portions of the data packet 200) within the data packet 200 to include control information associated with the payload of the data packet 200. For example, the communication protocol may specify that system metadata may be included at a location 220-a and/or a location 220-b, as illustrated in FIG. 2. Said another way, the communication protocol may provision the locations 220 for system metadata. In some cases, the host system may place one or more system metadata elements 225 in the locations 220. For example, the host system may include additional parity information or other system metadata to improve the reliability of the data packet 200. The memory system may be configured to store the system metadata bits 225 to one or more memory arrays provisioned for system metadata associated with the payload.

Additionally, the communication protocol may specify that communication control information, such as link parity information having one or more link parity elements 230, may be included at a location 235-a and/or 235-b, as illustrated in FIG. 2. Said another way, the communication protocol may provision the locations 235 for communication control information. As shown in FIG. 2, the one or more pins 210 may include a pin 210 used to communicate a subset of the one or more data elements 215, a subset of the one or more system metadata elements 225, and a subset of the one or more link parity elements 230.

The host system and/or the memory apparatus may support a link parity feedback mode in which the memory apparatus may report one or more write-link errors in a data packet by placing a value, referred to herein as a non-error-correcting code, in the one or more locations 235. A non-error-correcting code of an error control scheme may include an invalid or unlikely code, such as a code having a low likelihood of resulting from an error control operation on a data packet 200. For example, each bit of a non-error-correcting code may be a logical “1” (e.g., a 16-bit non-error-correcting code may be “1111111111111111”). Additionally, or alternatively, each bit of a non-error-correcting code may be a logical “1” except a single logical “0 ” (e.g., a 16-bit non-error-correcting code may be “1111111011111111”, “1110111111111111”, or another such sequence). By including multiple possible non-error-correcting codes, the memory system may improve the reliability of error reporting using link parity locations. For example, for an implementation in which the memory system reports a write-link error using a non-error-correcting code that is a sequence of all logical “1” , such a non-error-correcting code may experience an error during communication (e.g., a bit-flip), resulting in a sequence that includes all logical “1” except for a single logical “0”. Such a sequence may be recognized by the host system as being a non-error-correcting code, thus protecting such error reporting from single-bit errors.

By way of example, as part of generating a first data packet 200 for a write burst operation, the host system may generate the link parity elements 230 by performing an error control operation on a payload of the first data packet 200 (e.g., on one or more data elements 215), as well as the information in the locations 220 (e.g., the one or more system metadata elements 225). Said another way, the link parity information may be an ECC of the error control operation. The host system may place the link parity elements 230 in the locations 235. The host system may provide, and the memory system may obtain, the first data packet 200.

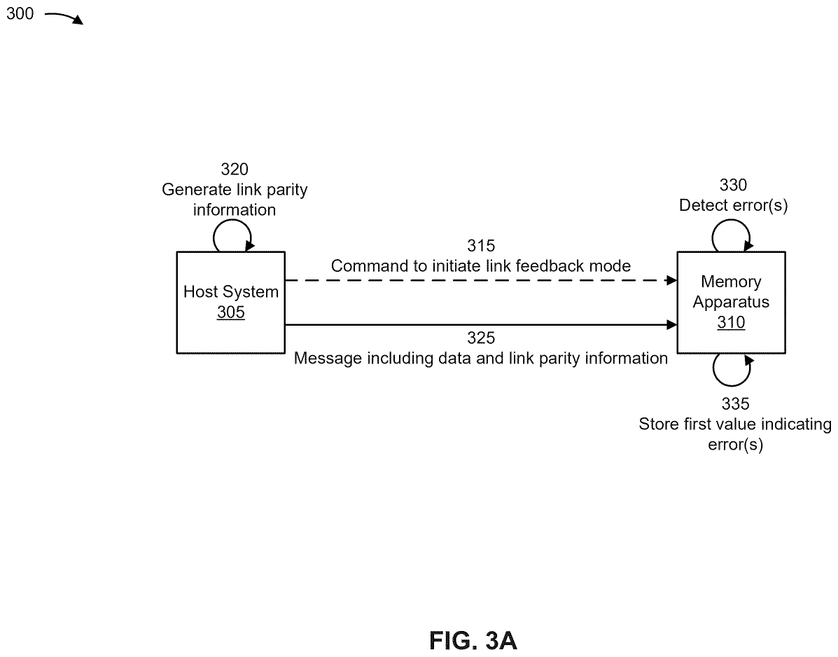

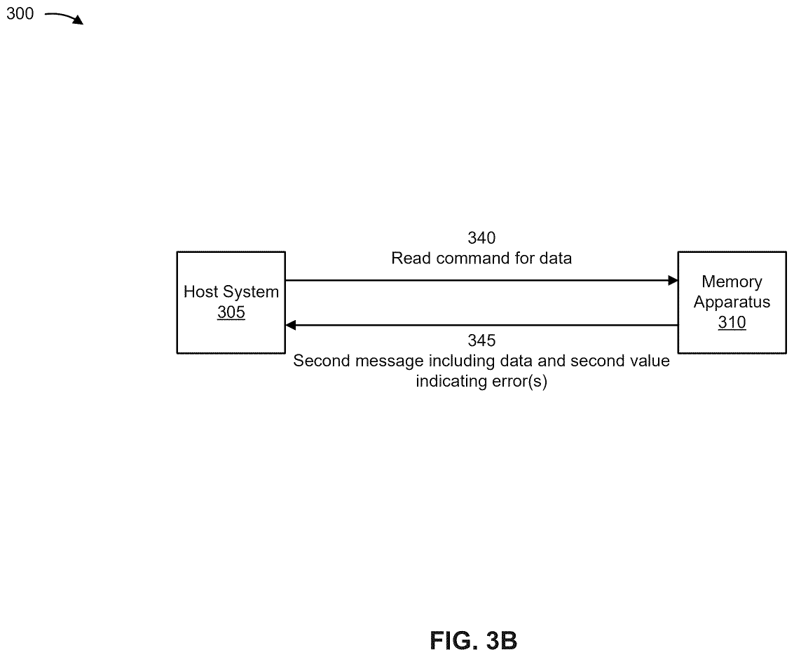

After obtaining the first data packet 200, the memory apparatus may use the link parity elements 230 to attempt to detect and/or correct one or more errors in the first data packet 200. If the memory system determines that the first data packet 200 includes one or more errors, then the memory system may store a value indicating that the data packet 200 includes the one or more errors, as explained in greater detail in connection with FIG. 3A. Subsequently, as part of a read operation for the payload, the memory system may generate a second data packet 200. The memory system may place a value, which may be a non-error-correcting code, indicating that the memory system detected one or more errors in the first data packet 200. The memory system may place the value in the locations 235. The memory system may provide, and the host system may obtain, the second data packet 200.

The host system and/or the memory system may be configured to recognize a non-error-correcting code, for example by storing a list or other indication of supported non-error-correcting codes. Accordingly, by identifying that the locations 235 of the second data packet 200 include a non-error-correcting code, the host system may determine that an error occurred as part of previously storing the payload to the memory system (e.g., the host system may identify that a write-link error occurred). Thus, the latency associated with such error reporting may be reduced. Such reduced latency may improve system performance, for example by reducing the time used to recover from errors, thereby maintaining higher throughput levels. Further, such error reporting may improve the ability of the host system to take corrective action, such as by increasing the amount of time available for the host system to attempt to rewrite or otherwise recover the data in the payload. Thus, reduced error reporting latency may increase the reliability of data written to the memory system.

As indicated above, FIG. 2 is provided as an example. Other examples may differ from what is described with regard to FIG. 2.

FIGS. 3A and 3B are diagrams of an example 300 of error reporting using link parity locations. The operations described in connection with FIGS. 3A and 3B may be performed by a system, such as the system 100 and/or one or more components thereof, such as the host system 105, the host interface 140, the memory system 110, the memory system controller 115, one or more memory devices 120, and/or one or more local controllers 125.

As shown in FIGS. 3A and 3B, the example 300 may include a host system 305 and a memory apparatus 310. The host system 305 may be the host system 105. The memory apparatus 310 may be or may include the memory system 110, one or more memory devices 120, and/or one or more controllers (e.g., the memory system controller 115 and/or one or more local controllers 125).

The example 300 illustrates a process to enable the host system 305 and the memory apparatus 310 to operate using a link parity feedback mode. While operating in the link parity feedback mode, the memory apparatus 310 may be configured to report one or more errors detected in a data packet written to the memory apparatus 310 (e.g., write-link errors) as part of a read operation for the data packet. For example, as shown by reference number 315, the host system 305 may provide, and the memory apparatus 310 may obtain, a command indicating that the memory apparatus 310 is to operate in the link parity feedback mode. In some examples, the memory apparatus 310 may store a value indicative of the link parity feedback mode, such as by setting a flag of (e.g., writing a logical “1” to) a mode register. In such examples, the command may be a mode register write command.

As shown by reference number 320, the host system 305 may generate link parity information for a payload and/or system metadata of a first data packet to be written to the memory apparatus 310. For example, the host system 305 may generate the link parity information by performing one or more error control operations on the payload and the system metadata. As shown by reference number 325, the host system 305 may provide, and the memory apparatus 310 may obtain, a message that includes the payload, the link parity information, and/or the system metadata (e.g., the first data packet). The memory apparatus 310 may store the payload and/or the system metadata to one or more memory devices of the memory apparatus 310

As shown by reference number 330, based on, in response to, or otherwise associated with obtaining the message, the memory apparatus 310 may perform an error control operation in accordance with an error control scheme on the first data packet using the link parity information. For example, the memory apparatus 310 may generate second link parity information using the payload and/or the system metadata. The memory apparatus 310 may compare the second link parity information to the first link parity information. If the first link parity information and the second link parity information match (e.g., if the first link parity information is equal to the second link parity information), then the memory apparatus 310 may determine that the first data packet does not include one or more errors. Alternatively, if the first link parity information and the second link parity information do not match, then the memory apparatus 310 may determine that the first data packet includes one or more errors.

In some examples, the one or more write link-errors may include one or more critical errors. A critical error may be an error that cannot be corrected using the error control scheme. For example, if the error control scheme is configured to correct a single-bit error, then a critical error may be a multi-bit error (MBE). Alternatively, if the error control scheme is configured to detect one or more errors, but not correct errors, then a critical error may be any error detected by the memory apparatus 310.

In some examples, the memory apparatus 310 may selectively perform aspects of the example 300 based on whether the memory apparatus 310 is operating in the link parity feedback mode. As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination. As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

For example, if the memory apparatus 310 is not operating in the link parity feedback mode, then the memory apparatus 310 may store a value (e.g., a flag or other indication) to one or more fault-mode registers. A fault-mode register may be a register within the memory apparatus 310 configured to log one or more error conditions, such as critical errors, write-link errors, or other conditions detected during operation. A fault-mode register may include a binary indicator (e.g., a flag), a detailed error code, and/or a value that provides additional context about the nature and severity of a fault. In such examples, the host system 305 may provide, and the memory apparatus 310 may obtain, a request for a status of the one or more fault-mode registers. Based on, in response to, or otherwise associated with obtaining the request, the memory apparatus 310 may provide a message indicating the value (e.g., the status) of the one or more fault-mode registers to the host system 305.

Alternatively, if the memory apparatus 310 is operating in the link parity feedback mode, then as shown by reference number 335, the memory apparatus 310 may store an indication (e.g., a first value) that the first data packet includes the one or more errors. In some examples, to store the indication, the memory apparatus 310 may store a value, such as a flag or other indicator, to one or more fault-mode registers. A fault-mode register may be a register within the memory apparatus 310 configured to log one or more error conditions, such as critical errors, write-link errors, or other conditions detected during operation. A fault-mode register may include a binary indicator (e.g., a flag), a detailed error code, and/or a value that provides additional context about the nature and severity of a fault.

Additionally, or alternatively, to store the indication, the memory apparatus 310 may store a value, such as a non-error-correcting code, to one or memory arrays provisioned for parity information associated with the data packet. In some examples, the memory apparatus 310 may provision storage space within a memory device (e.g., a memory device 120) to store parity information, such as on-die parity information. On-die parity information for a payload may include parity information generated by the memory apparatus 310 using the payload. On-die parity information may be used to detect and/or correct errors in the payload that occur as part of internal processing of the payload (e.g., errors that occur as part of the memory apparatus 310 storing and/or retrieving the payload).

However, if the memory apparatus 310 is operating in the link parity feedback mode, then the memory apparatus 310 may use the one or memory arrays provisioned for parity information to instead store the non-error-correcting code. In such cases, the memory apparatus 310 may refrain from generating on-die parity information, which may reduce the processing load on the memory apparatus 310 and thus improve system performance.

As shown in FIG. 3B, the example 300 further illustrates a process to enable the memory apparatus 310 to report the one or more write-link errors to the host system 305. For example, as shown by reference number 340, the host system 305 may provide, and the memory apparatus 310 may obtain, a read request to retrieve the payload. Based on, in response to, or otherwise associated with obtaining the read request, the memory apparatus 310 may retrieve the payload and, in some cases, the non-error-correcting code from the one or more memory arrays.

The memory apparatus 310 may place the non-error-correcting code in one or more portions of a second data packet provisioned for communication control information (e.g., one or more locations 235). As shown by reference number 345, the memory apparatus 310 may provide, and the host system 305 may obtain, a second message that includes the payload and the non-error-correcting code. For example, the second message may include or may be the second data packet that includes the payload and the non-error-correcting code. In some examples, the memory apparatus 310 may refrain from generating second link parity information for the second data packet, which may reduce the processing load on the memory apparatus 310 and thus improve system performance.

The host system 305 may identify that the second data packet includes the non-error-correcting code, and may thus determine that one or more write-link errors occurred as part of writing the original data packet. In some examples, the host system 305 may take one or more corrective actions, such as rewriting the data packet and/or retrieving the original data from a backup source, among other examples. By enabling error reporting using link parity locations, the latency associated with such error reporting may be reduced. Such reduced latency may improve system performance, for example by reducing the time used to recover from errors, thereby maintaining higher throughput levels.

As indicated above, FIGS. 3A and 3B are provided as an example. Other examples may differ from what is described with regard to FIGS. 3A and 3B.

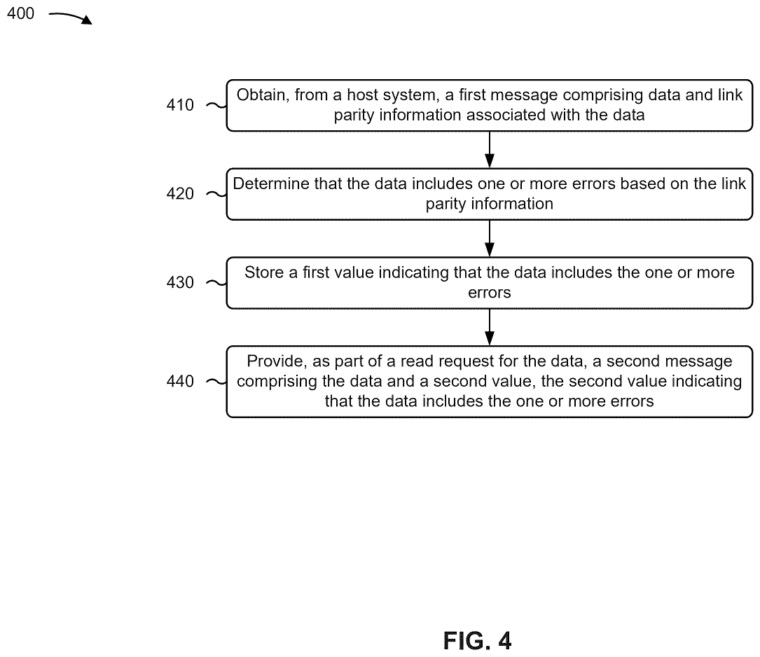

FIG. 4 is a flowchart of an example method 400 associated with error reporting using link parity locations. In some implementations, a memory apparatus (e.g., the memory system 110, the memory apparatus 310) may perform or may be configured to perform the method 400. In some implementations, another device or a group of devices separate from or including the memory apparatus (e.g., the host system 105, the host interface 140, and/or the host system 305) may perform or may be configured to perform the method 400. Additionally, or alternatively, one or more components of the memory apparatus (e.g., the memory system controller 115, one or more memory device 120) may perform or may be configured to perform the method 400. Thus, means for performing the method 400 may include the memory apparatus and/or one or more components of the memory apparatus. Additionally, or alternatively, a non-transitory computer-readable medium may store one or more instructions that, when executed by the memory apparatus, cause the memory apparatus to perform the method 400.

As shown in FIG. 4, the method 400 may include obtaining, from a host system, a first message comprising data and link parity information associated with the data (block 410). As further shown in FIG. 4, the method 400 may include determining that the data includes one or more errors based on the link parity information (block 420). As further shown in FIG. 4, the method 400 may include storing a first value indicating that the data includes the one or more errors (block 430). As further shown in FIG. 4, the method 400 may include providing, as part of a read request for the data, a second message comprising the data and a second value, the second value indicating that the data includes the one or more errors (block 440).

The method 400 may include additional aspects, such as any single aspect or any combination of aspects described below and/or described in connection with one or more other methods or operations described elsewhere herein.

In a first aspect, the second value comprises a non-error-correcting code of an error control scheme associated with the link parity information.

In a second aspect, alone or in combination with the first aspect, the second value is located in a portion of the second message provisioned for second link parity information.

In a third aspect, alone or in combination with one or more of the first and second aspects, determining that the data comprises the one or more errors comprises generating second link parity information using the data, and comparing the second link parity information to the link parity information to determine that the second link parity information does not match the link parity information.

In a fourth aspect, alone or in combination with one or more of the first through third aspects, storing the first value comprises storing the first value to one or more memory arrays provisioned for parity information corresponding to the data.

In a fifth aspect, alone or in combination with one or more of the first through fourth aspects, storing the first value comprises storing the first value to one or more fault-mode registers of the memory apparatus.

In a sixth aspect, alone or in combination with one or more of the first through fifth aspects, the first message further comprises metadata associated with the data, and storing the first value comprises storing the metadata to one or more memory arrays provisioned for system metadata associated with the data.

In a seventh aspect, alone or in combination with one or more of the first through sixth aspects, obtaining the first message comprises obtaining a subset of the data via a pin of one or more pins of a bus between the host system and the memory apparatus, and obtaining a subset of the link parity information via the pin.

In an eighth aspect, alone or in combination with one or more of the first through seventh aspects, the method 400 includes refraining from generating on-die

parity information for the data based on determining that the data includes the one or more errors.

In a ninth aspect, alone or in combination with one or more of the first through eighth aspects, the method 400 includes refraining, as part of performing the read request, from generating second link parity information based on determining that the data includes the one or more errors.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

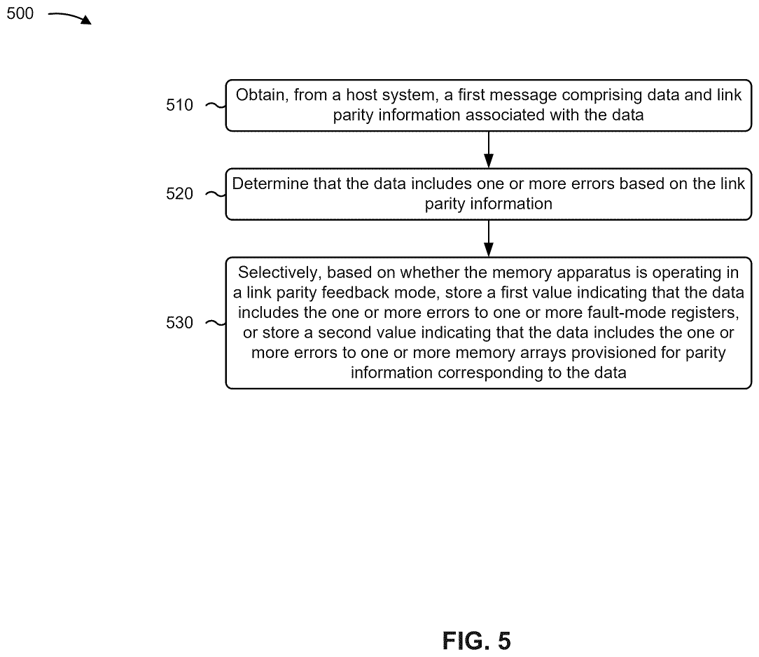

FIG. 5 is a flowchart of an example method 500 associated with error reporting using link parity locations. In some implementations, a memory apparatus (e.g., the memory system 110, the memory apparatus 310) may perform or may be configured to perform the method 500. In some implementations, another device or a group of devices separate from or including the memory apparatus (e.g., the host system 105, the host interface 140, and/or the host system 305) may perform or may be configured to perform the method 500. Additionally, or alternatively, one or more components of the memory apparatus (e.g., the memory system controller 115, one or more memory device 120) may perform or may be configured to perform the method 500. Thus, means for performing the method 500 may include the memory apparatus and/or one or more components of the memory apparatus. Additionally, or alternatively, a non-transitory computer-readable medium may store one or more instructions that, when executed by the memory apparatus, cause the memory apparatus to perform the method 500.

As shown in FIG. 5, the method 500 may include obtaining, from a host system, a first message comprising data and link parity information associated with the data (block 510). As further shown in FIG. 5, the method 500 may include determining that the data includes one or more errors based on the link parity information (block 520). As further shown in FIG. 5, the method 500 may include selectively, based on whether the memory apparatus is operating in a link parity feedback mode, storing a first value indicating that the data includes the one or more errors to one or more fault-mode registers, or storing a second value indicating that the data includes the one or more errors to one or more memory arrays provisioned for parity information corresponding to the data (block 530).

The method 500 may include additional aspects, such as any single aspect or any combination of aspects described below and/or described in connection with one or more other methods or operations described elsewhere herein.

In a first aspect, the method 500 includes providing, based on the memory apparatus operating in the link parity feedback mode and as part of a read request for the data, a second message comprising the data and the second value to the host system.

In a second aspect, alone or in combination with the first aspect, the method 500 includes refraining, as part of performing the read request, from generating second link parity information based on determining that the data includes the one or more errors.

In a third aspect, alone or in combination with one or more of the first and second aspects, the second value is located in a portion of the second message provisioned for second link parity information.

In a fourth aspect, alone or in combination with one or more of the first through third aspects, the method 500 includes refraining, based on the memory apparatus operating in the link parity feedback mode and based on determining that the data includes the one or more errors, from generating on-die parity information.

In a fifth aspect, alone or in combination with one or more of the first through fourth aspects, the method 500 includes obtaining, from the host system and based on the memory apparatus not operating in the link parity feedback mode, a request for a status of the one or more fault-mode registers, and providing, to the host system, a second message indicating the status.

In a sixth aspect, alone or in combination with one or more of the first through fifth aspects, the method 500 includes obtaining, from the host system, a command indicating that the memory apparatus is to operate in the link parity feedback mode, and storing, to a mode register, a third value indicating that the memory apparatus is operating in the link parity feedback mode.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

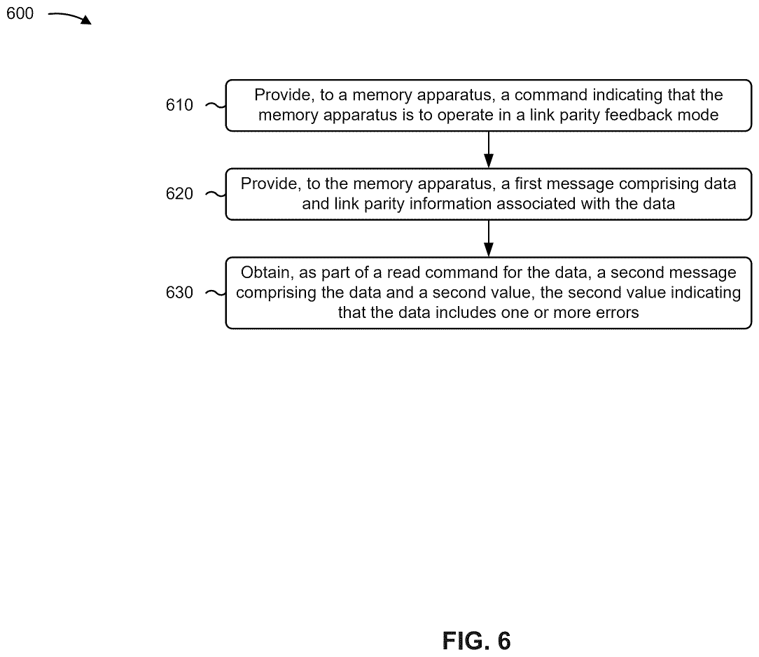

FIG. 6 is a flowchart of an example method 600 associated with error reporting using link parity locations. In some implementations, a host system (e.g., the host system 105 and/or the host system 305) may perform or may be configured to perform the method 600. In some implementations, another device or a group of devices separate from or including the host system (e.g., the memory system 110, the memory apparatus 310) may perform or may be configured to perform the method 600. Additionally, or alternatively, one or more components of the host system (e.g., the host processor 150) may perform or may be configured to perform the method 600. Thus, means for performing the method 600 may include the host system and/or one or more components of the host system. Additionally, or alternatively, a non-transitory computer-readable medium may store one or more instructions that, when executed by the host system, cause the host system to perform the method 600.

As shown in FIG. 6, the method 600 may include providing, to a memory apparatus, a command indicating that the memory apparatus is to operate in a link parity feedback mode (block 610). As further shown in FIG. 6, the method 600 may include providing, to the memory apparatus, a first message comprising data and link parity information associated with the data (block 620). As further shown in FIG. 6, the method 600 may include obtaining, as part of a read request for the data, a second message comprising the data and a second value, the second value indicating that the data includes one or more errors (block 630).

The method 600 may include additional aspects, such as any single aspect or any combination of aspects described below and/or described in connection with one or more other methods or operations described elsewhere herein.

In a first aspect, the method 600 includes generating the link parity information using the data.

In a second aspect, alone or in combination with the first aspect, the second value comprises a non-error-correcting code of an error control scheme associated with the link parity information.

In a third aspect, alone or in combination with one or more of the first and second aspects, the second value is located in a portion of the second message provisioned for second link parity information.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

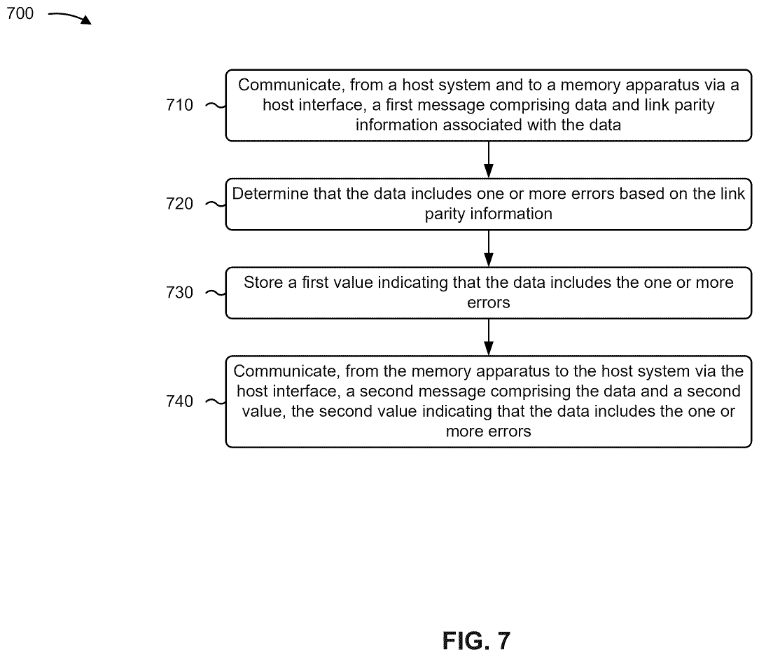

FIG. 7 is a flowchart of an example method 700 associated with error reporting using link parity locations. In some implementations, a system (e.g., the host system 105, the memory system 110, the host system 305, and/or the memory apparatus 310) may perform or may be configured to perform the method 700. Additionally, or alternatively, one or more components of the system (e.g., the host interface 140, the host processor 150, the memory system controller 115, and/or one or more memory devices 120) may perform or may be configured to perform the method 700. Thus, means for performing the method 700 may include the system and/or one or more components of the system. Additionally, or alternatively, a non-transitory computer-readable medium may store one or more instructions that, when executed by the system, cause the system to perform the method 700.

As shown in FIG. 7, the method 700 may include communicating, from a host system and to a memory apparatus via a host interface, a first message comprising data and link parity information associated with the data (block 710). As further shown in FIG. 7, the method 700 may include determining that the data includes one or more errors based on the link parity information (block 720). As further shown in FIG. 7, the method 700 may include storing a first value indicating that the data includes the one or more errors (block 730). As further shown in FIG. 7, the method 700 may include communicating, from the memory apparatus to the host system via the host interface, a second message comprising the data and a second value, the second value indicating that the data includes the one or more errors (block 740).

The method 700 may include additional aspects, such as any single aspect or any combination of aspects described below and/or described in connection with one or more other methods or operations described elsewhere herein.

In a first aspect, the method 700 includes communicating, via the host interface and to the memory apparatus, a command indicating that the memory apparatus is to operate in a link parity feedback mode, and storing, to a mode register of the memory apparatus, a third value indicating that the memory apparatus is operating in the link parity feedback mode.

In a second aspect, alone or in combination with the first aspect, the second value comprises a non-error-correcting code of an error control scheme associated with the link parity information.

In a third aspect, alone or in combination with one or more of the first and second aspects, the second value is located in a portion of the second message provisioned for second link parity information.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a memory apparatus includes one or more components configured to: obtain, from a host system, a first message comprising data and link parity information associated with the data; determine, by the memory apparatus, that the data includes one or more errors based on the link parity information; store, by the memory apparatus, a first value indicating that the data includes the one or more errors; and provide, to the host system and as part of a read request for the data, a second message comprising the data and a second value, the second value indicating that the data includes the one or more errors.

In some implementations, a memory apparatus includes one or more components configured to: obtain, from a host system, a first message comprising data and link parity information associated with the data; determine, by the memory apparatus, that the data includes one or more errors based on the link parity information; and selectively, based on whether the memory apparatus is operating in a link parity feedback mode, store a first value indicating that the data includes the one or more errors to one or more fault-mode registers or store a second value indicating that the data includes the one or more errors to one or more memory arrays provisioned for parity information corresponding to the data.

In some implementations, a host system includes one or more components configured to: provide, to a memory apparatus, a command indicating that the memory apparatus is to operate in a link parity feedback mode; provide, to the memory apparatus, a first message comprising data and link parity information associated with the data; and obtain, from the memory apparatus and as part of a read request for the data, a second message comprising the data and a second value, the second value indicating that the data includes one or more errors.

In some implementations, a system includes: a host system; a memory apparatus; a host interface between the host system and the memory apparatus; and one or more controllers configured to: communicate, via the host interface and to the memory apparatus, a first message comprising data and link parity information associated with the data; determine, by the memory apparatus, that the data includes one or more errors based on the link parity information; store, at the memory apparatus, a first value indicating that the data includes the one or more errors; and communicate, via the host interface and to the host system, a second message comprising the data and a second value, the second value indicating that the data includes the one or more errors.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory apparatus, comprising:
one or more components configured to:
obtain, from a host system, a first message comprising data and link parity information associated with the data;
determine, by the memory apparatus, that the data includes one or more errors based on the link parity information;
store, by the memory apparatus, a first value indicating that the data includes the one or more errors; and
provide, to the host system and as part of a read request for the data, a second message comprising the data and a second value, the second value indicating that the data includes the one or more errors.

2. The memory apparatus of claim 1, wherein the second value comprises a non-error-correcting code of an error control scheme associated with the link parity information.

3. The memory apparatus of claim 1, wherein the second value is located in a portion of the second message provisioned for second link parity information.

4. The memory apparatus of claim 1, wherein determining that the data includes the one or more errors comprises:
generating second link parity information using the data; and
comparing the second link parity information to the link parity information to determine that the second link parity information does not match the link parity information.

5. The memory apparatus of claim 1, wherein storing the first value comprises:
storing the first value to one or more memory arrays provisioned for parity information corresponding to the data.

6. The memory apparatus of claim 1, wherein storing the first value comprises:
storing the first value to one or more fault-mode registers of the memory apparatus.

7. The memory apparatus of claim 1, wherein the first message further comprises metadata associated with the data, and wherein the one or more components are further configured to:
store the metadata to one or more memory arrays provisioned for system metadata associated with the data.

8. The memory apparatus of claim 1, wherein, to obtain the first message, the one or more components are configured to:
obtain a subset of the data via a pin of one or more pins of a bus between the host system and the memory apparatus; and
obtain a subset of the link parity information via the pin.

9. The memory apparatus of claim 1, wherein the one or more components are further configured to:
refrain from generating on-die parity information for the data based on determining that the data includes the one or more errors.

10. The memory apparatus of claim 1, wherein the one or more components are further configured to:
refrain, as part of performing the read request, from generating second link parity information based on determining that the data includes the one or more errors.

11. A memory apparatus, comprising:
one or more components configured to:
obtain, from a host system, a first message comprising data and link parity information associated with the data;
determine, by the memory apparatus, that the data includes one or more errors based on the link parity information; and
selectively, based on whether the memory apparatus is operating in a link parity feedback mode, store a first value indicating that the data includes the one or more errors to one or more fault-mode registers or store a second value indicating that the data includes the one or more errors to one or more memory arrays provisioned for parity information corresponding to the data.

12. The memory apparatus of claim 11, wherein the one or more components are further configured to:
provide, based on the memory apparatus operating in the link parity feedback mode and as part of a read request for the data, a second message comprising the data and the second value to the host system.

13. The memory apparatus of claim 12, wherein the one or more components are further configured to:
refrain, as part of performing the read request, from generating second link parity information based on determining that the data includes the one or more errors.

14. The memory apparatus of claim 12, wherein the second value is located in a portion of the second message provisioned for second link parity information.

15. The memory apparatus of claim 11, wherein the one or more components are further configured to:
refrain, based on the memory apparatus operating in the link parity feedback mode and based on determining that the data includes the one or more errors, from generating on-die parity information.

16. The memory apparatus of claim 11, wherein the one or more components are further configured to:
obtain, from the host system and based on the memory apparatus not operating in the link parity feedback mode, a request for a status of the one or more fault-mode registers; and
provide, to the host system, a second message indicating the status.

17. The memory apparatus of claim 11, wherein the one or more components are further configured to:
obtain, from the host system, a command indicating that the memory apparatus is to operate in the link parity feedback mode; and
store, to a mode register, a third value indicating that the memory apparatus is operating in the link parity feedback mode.

18. A host system, comprising: one or more components configured to:
provide, to a memory apparatus, a command indicating that the memory apparatus is to operate in a link parity feedback mode;
provide, to the memory apparatus, a first message comprising data and link parity information associated with the data; and
obtain, from the memory apparatus and as part of a read request for the data, a second message comprising the data and a second value, the second value indicating that the data includes one or more errors.

19. The host system of claim 18, wherein the one or more components are further configured to:
generate the link parity information using the data.

20. The host system of claim 18, wherein the second value comprises a non-error-correcting code of an error control scheme associated with the link parity information.

21. The host system of claim 18, wherein the second value is located in a portion of the second message provisioned for second link parity information.

22. A system, comprising:
a host system;
a memory apparatus;
a host interface between the host system and the memory apparatus; and
one or more controllers configured to:
communicate, via the host interface and to the memory apparatus, a first message comprising data and link parity information associated with the data;
determine, by the memory apparatus, that the data includes one or more errors based on the link parity information;
store, at the memory apparatus, a first value indicating that the data includes the one or more errors; and
communicate, via the host interface and to the host system, a second message comprising the data and a second value, the second value indicating that the data includes the one or more errors.

23. The system of claim 22, wherein the one or more controllers are further configured to:
communicate, via the host interface and to the memory apparatus, a command indicating that the memory apparatus is to operate in a link parity feedback mode; and
store, to a mode register of the memory apparatus, a third value indicating that the memory apparatus is operating in the link parity feedback mode.

24. The system of claim 22, wherein the second value comprises a non-error-correcting code of an error control scheme associated with the link parity information.

25. The system of claim 22, wherein the second value is located in a portion of the second message provisioned for second link parity information.
